(19) United States
(12) Patent Application Publication
(10) Pub. No.: US 2011/0027501 A1
(43) Pub. Date: Feb. 3, 2011

(54) ARTIFICIAL ANTIQUE ARCHITECTURAL WOOD SUBSTRATE

(76) Inventor: Jenwei Guo, Kunshan (CN)

Correspondence Address: ITALIA IP, 3500 WEST OLIVE AVE., SUITE 300, BURBANK, CA, 91505, US

(21) Appl. No.: 12/511,546

(22) Filed: Jul. 29, 2009

(51) Int. Cl. B32B 3/10; B05D 3/00; B05D 5/00; B05D 3/06; B27M 1/08

(52) U.S. Cl. 428/22; 427/325; 427/280; 427/542; 427/541; 144/358; 144/359

(57) ABSTRACT

Wood substrate having antique appearance effects, based on only one structural substrate, which may utilize composites such as plywood, particle board, high density board, bamboo, non-wood fiber boards and other synthetic or semi-synthetic materials. A board using a composite may be formed to desired dimensions, and optionally may have tongue and groove or other interconnection structure. The board may have holes, grooves, cracks, and other intruding formations imposed therein, and may have simulated patches formed thereon. The board may then have wood grain printed thereon. Abraded texturing may be introduced to the surface. Other treatments such a staining, sealing, sanding, drying, and coating may be provided.

### FIELD OF THE INVENTION

The present invention pertains to architectural wood substrate, and more particularly to a new wood based wood substrate product which is manufactured to have the appearance of antique wood.

### BACKGROUND OF THE INVENTION

Antique architectural materials are prized for the esthetic effect of the antique surface. Wood substrate is regarded as being of greater interest when bearing markings which result from long term use. For example, nail holes, worm and insect borings, and other effects which typically occur with actual wood subjected to many years service are felt to impart a certain desirability. Wood substrate which has been reclaimed from old buildings is once source of building materials which already bear these markings. However, such wood substrate commands a significant premium in commercial distribution outlets.

New wood substrate which is intentionally provided with antique effects has been commercially available. Such wood substrate may for example have patterns including wood grain, nail holes, worm and insect borings, and other surface features printed on wood substrate surfaces. However, such printed or painted features are typically laid down on veneers which are intended for receiving such markings. The painted veneer is then adhered or otherwise bonded to a structural layer of the wood substrate being produced.

There exists a need in the prior art for a commercial wood substrate product which simulates an antique condition which is less expensive than traditional simulated antique wood substrate.

### SUMMARY OF THE INVENTION

The present invention addresses the above stated need by providing a method of producing a simulated antique condition in wood flooring wood substrate, and by providing the resultant wood substrate product. The wood substrate product requires only one structural substrate rather than comprising a plurality of laminated substrates which must be joined together. The structural substrate may comprise virgin or solid wood as cut from the original tree, plywood, particle board, high density board, bamboo, and non-wood fiber boards.

In a typical process which would be used in commercial practice, the selected raw material is cut to desired dimensions which correspond to a predetermined nominal size, and may be subjected to finishing treatment if desired, such as sanding. Sanding finishes the exposed surface or principal face, where the principal face is that surface which will be exposed to occupied spaces and rooms within the building. Lateral connection structure, such as tongues and grooves for engaging abutting sections of finished wood substrate, may then be formed. Desired effects of antique or used wood are then imparted to the exposed surface. These desired effects may include simulations of occurrences of distress, such as holes, cracks, evidence of infestations by pests, and the like. The wood substrate may be stained to produce a desired color. Simulated wood grain may then be printed onto the exposed surface using printing rolls or rollers engraved with the wood grain pattern. The surface may then be finished by providing a protective coat such as by lacquering. Other protective finishing products may be applied as desired.

While simulated antique wood products are known, the invention results in the only simulated antique wood substrate product known to the applicant which is made from a monolithic structural substrate, and which does not require plural substrates or laminations to be joined together. This enables finished boards to be fabricated and offered on the commercial market as realistic yet inexpensive simulated antique or reclaimed wood substrate. The product is especially suited for use in flooring.

### BRIEF DESCRIPTION OF THE DRAWINGS

Similar reference characters denote corresponding features consistently throughout the attached drawings.

FIG. 1 is a perspective view of a board according to several aspects of the present invention.

FIG. 2 is a diagrammatic representation of wood grain which may be applied to a board such as the board of FIG. 1.

FIG. 3 is a block diagram summarizing steps of producing a board according to at least one aspect of the invention.

### DETAILED DESCRIPTION

The present invention may be thought of as a method of producing wood substrate displaying simulated antique characteristics at the principal face of the wood substrate. More specifically, characteristics which are popularly associated with antique wood substrate typically comprise nail holes, cracks from drying and aging, evidence of pest or animal infestation such as worm tunnels or borings, and the like. Also, simulation of repair procedures such as puttying and patching may be seen in the public eye as characteristics of antique wood.

The process starts with a single, monolithic structural substrate which is sized and shaped fairly closely to the final commercial product. It must be stressed that the present invention uses only one structural substrate. The structural substrate may comprise any material, natural or synthetic or both, which has inherent strength and other characteristics suitable for use in bearing weight and wear that would occur in the intended use. For example, because flooring is one very advantageous application of the invention, the selected substrate will have strength, durability, and other characteristics generally deemed acceptable for flooring products.

It should further be stressed that as employed herein, the term “monolithic” does not necessarily imply that only one constituent material or chemical substance is present in the structural substrate. Rather, it signifies that the structural portion of the final product includes only a single substance or combination of constituent materials initially formed as a single piece from each side to an opposed side. Virgin wood could be processed according to the novel method, but it is contemplated that considerable economies can be achieved by using composite material in place of virgin wood, since the antiquing effects enable much less expensive composites to serve in place of the more expensive virgin wood.

Illustratively, the structural substrate may comprise plywood, particle board, high density board, bamboo, non-wood fiber boards and other synthetic or semi-synthetic materials that are built up from smaller pieces which are adhered together to form a sheet. The resultant sheet becomes the sole structural substrate in the final process.

The process only imparts antique qualities and finishing coatings and other surface treatments to the selected structural substrate.

In the novel method, a structural substrate having strength characteristics meeting the demands of the application is configured substantially as a parallelepiped of nominal thickness. The configuration may be that of typical boards as provided on the commercial market for building purposes. Such boards are typically provided in predetermined standard thicknesses, and are usually available in a limited number of nominal lengths and nominal widths.

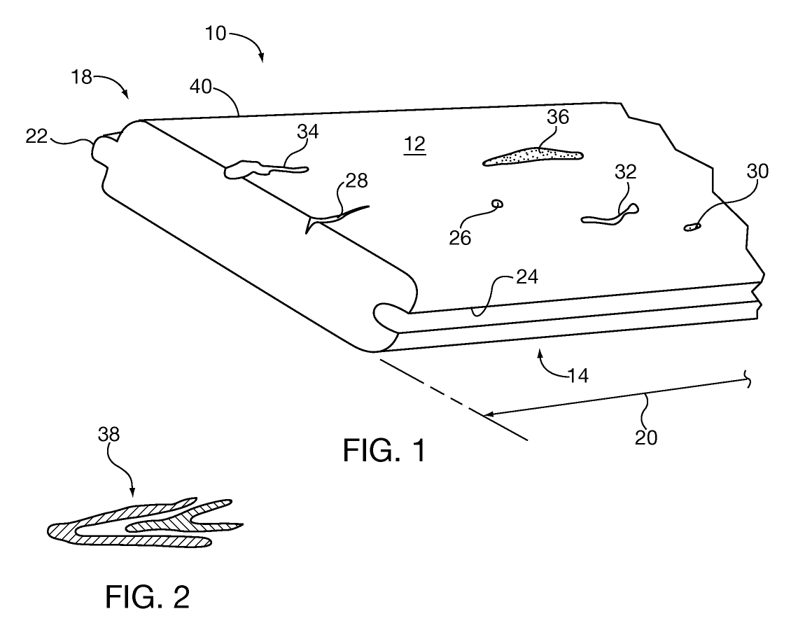

An illustrative board 10 is shown in FIG. 1. The board 10 generally comprises a parallelepiped, having a broad principal face 12 and an opposed bottom face 14, respective right and left sides 16, 18 of nominal thickness, such as between six and twenty millimeters, and a length 20. It will be appreciated that terms such as right and left, and even length are employed herein only for semantic convenience. Obviously, a board such as the board 10 may be held and installed in any desired orientation such that there is no true right, left, bottom, or top. Also, length may be minimal, such as for example the case with square boards (not shown) which are intended to be used as wood tiles.

An interconnection profile, such as a tongue 22 formed in the right side 16 and a corresponding groove 24 formed on the opposed left side 14, may be provided or formed in the board 10. The interconnection profile will of course be considered as not affecting the overall form of the parallelepiped generally defined by the board 10.

Once the structural substrate such as the board 10 has been obtained as or formed to desired nominal dimensions, a distress feature is imposed into its principal face 12, that being the broad surface of a board such as the board 10 which is exposed to view after installation into an architectural construction. An architectural construction may be any feature of a building or similar structure, such as floors, ceilings, partitions, clapboard, soffits, trim, doors and hatches, stairs, shutters, stages and platforms, and the like. For the purposes of this invention, architectural constructions will also be understood to encompass furniture, boats, cabinets, wagons, decorative boxes and barrels, window frames, planters, rifle stocks, wooden machines and frames thereof, and other articles wherein the wood is provided as a structural member having one surface exposed to view. A distress feature is three dimensional evidence of a disruption to otherwise virgin or undisturbed wood substrate, and in the sense intended, will be understood to comprise holes such as the hole 26, cracks such as the crack 28, bores or drillings such as the drilling 30, and other physical intrusions into the wood substrate or board which would arise from splitting of the wood over time, use of tools such as drills to form holes, driving of fasteners into the wood and perhaps removal of the fasteners, tunnels such as the tunnel 34 and other evidence of boring by insects and other pests, grooves and troughs and the like formed for example by hammering a nail lying on its side into the surface of the wood, such as the groove 32, and like intrusions. It would also be possible to simulate repairs to distressed boards and wood substrate, such as by simulating putty used to patch holes, such as the simulated patch 36, small pieces of wood applied to fill voids in the surface of the boards and wood substrate (not shown), and like minor repairs.

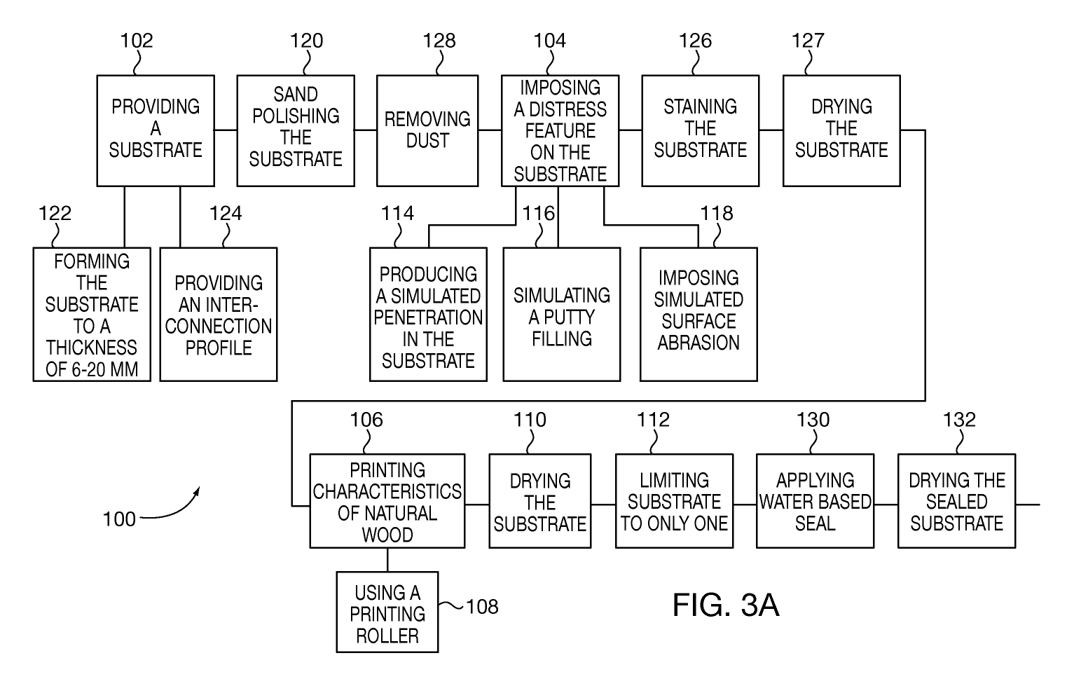

Because the constituent material of the structural substrate may reveal its origins if built up from small pieces, such as plywood, particle board, fiber board, and the like, the surface may not look like antique virgin or whole wood substrate. Therefore, a surface appearance such as natural wood grain (shown as an abstract pattern 38 in FIG. 2) or coloring simulating a smooth surface formed in natural or virgin wood may be printed onto the structural substrate after the distress features have been imposed.

Beyond imparting commercial sizing to the board 10, forming connection structure such as the tongue 22 and groove 24, imposing distress features such as the distress features 26, 28, 30, 32, 34, 36, and printing a surface feature thereon, the board 10 may be treated to improve its performance as an architectural product. Illustratively, the surface, such as the principal face 12 if not all surfaces of the board 10 may be sanded or otherwise abraded, planed or otherwise shaved or cut on the surface, and coated with diverse products to protect and enhance the appearance of the board 10 and its various features. These treatments may include barrier coat, base stain, sealers, gloss enhancers, topcoats, preservatives and coatings for protecting against ultraviolet fading, loss or modification of color, wear, infestation by pests, penetration by foreign fluids, abrasion resistance, noise attenuation, and the like.

An exemplary fabrication method will now be set forth. A substrate such as the board 10 which has been formed to desired dimensions and configuration may be hand sculpted to impart suitable distress features. Beyond the specific distress features, the principal face of the board, such as the principal face 12 of the board 10, may be textured by for example by imposing therein a simulated surface abrasion marking such as a saw mark 40 (see FIG. 1). Of course, simulated surface abrasion marking may include scratches, file marks, scraper marks, planing tool marks, and other marking which may be characteristic of a particular tool or procedure, or which may represent general wear or indeterminate causes. Texturing may include any combination of specific markings.

A barrier coat may then be applied and dried by for example an infrared source. The substrate may then be sanded and stained, brushed, and dried, again for example by an infrared source. The board may then be printed to bear wood grain or other internal surface marking or coloring, preferably using an engraved platen or roller (not shown). Printing ink or coloring may be dried by for example an infrared source. Additional sealers such as an elastic sealer, an alumina sealer, and a low gloss sealer may be applied, dried by an appropriate way such as by exposure to an ultraviolet source, and sanded in successive operations. Sealers may be redundantly applied, dried, and sanded. One or more topcoats may then be applied and dried using any drying method, such as ultraviolet or infrared exposure. Topcoats may be redundantly applied and dried.

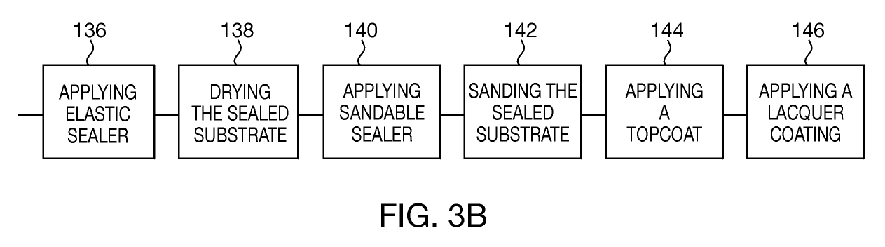

As shown in FIG. 3, the invention may be thought of as a method 100 producing wood substrate displaying simulated antique characteristics at the principal face of the wood substrate. The method 100 may comprise a step 102 of providing a structural substrate configured substantially as a parallelepiped having a principal face which will be exposed to view after the structural substrate is incorporated into an architectural construction, such as the board 10. The subsequently recited steps may be understood to refer to the board 10, to the exemplary method described above, or to both.

The method 100 may comprise a step 104 of imposing at least one distress feature directly onto the principal face of the structural substrate.

The method 100 may comprise a step 106 of printing indicia on the principal face of the structural substrate, wherein the indicia simulates internal surface characteristics of natural wood. The step 106 may comprise a step 108 of using printing rolls engraved with a natural wood grain pattern to print the wood grain pattern on the structural substrate.

Regardless of the method of printing, the method 100 may comprise a further step 110 of drying at least the principal face of the structural substrate as a step which immediately follows printing indicia on the principal face of the structural substrate.

The method 100 may comprise a step 112 of limiting the number of structural substrates in the final product to one and only one structural substrate, which said one structural substrate is that which has had imposed thereon the distress features.

The step 104 of imposing at least one distress feature may comprise a further step 114 of producing at least one simulated penetration in the principal face of the structural substrate, wherein each simulated penetration is a member of the group including nail holes, drilled holes, cracks, and pest infestation borings. As an alternative to the step 114, or if desired in addition to the step 114, the step 104 may comprise a step 116 of step of simulating the appearance of putty filling of at least one recess formed in the simulated wood substrate. As a further alternative, or in a further addition, the step 104 may comprise a step 118 of imposing at least one simulated surface abrasion marking into the structural substrate.

The method 100 may include a step 120 of sand polishing the principal face of the structural substrate prior to reproducing distress features.

The method 100 may comprise a step 122 of forming the structural substrate to a thickness within the range of six to twenty millimeters, which is a typical thickness for flooring, clapboard, siding, and the like.

The method 100 may comprise a step 124 of providing an interconnection profile at the lateral surfaces of the structural substrate.

The method 100 may comprise a step 126 of staining at least the principal face to impart a desired coloring to the structural substrate. The stain may be water based. The method 100 may comprise a subsequent step 127 of drying the structural substrate using a blower.

The method 100 may comprise an initial step 128 of removing dust from the structural substrate, for example, prior to printing indicia on the principal face of the structural substrate.

The method 100 may comprise a step 130 of applying a water based seal to the structural substrate, and a subsequent step 132 of drying the structural substrate using infrared radiation.

The method 100 may comprise a step 136 of applying an elastic sealer at least to the principal face of the substrate, and a subsequent step 138 of drying the elastic sealer using ultraviolet radiation.

The method 100 may comprise a step 140 of applying a sandable sealer at least to the principal face of the structural substrate, and a subsequent step 142 of sanding the sealed principal face of the structural substrate.

The method 100 may comprise a step 144 of applying a topcoat to the structural substrate.

The method 100 may comprise a step 146 of applying a lacquer finishing coating at least to the principal face of the wood substrate.

It should be understood that while exemplary methods are set forth herein, any method according to at least one aspect of the invention may be practiced wherein steps described herein may be omitted where feasible, or practiced in a different order than that set forth where feasible. Also, steps may be practiced redundantly where desired.

The invention may also be thought of as a finished piece of wood substrate displaying simulated antique characteristics which has been fabricated by any method according to the invention.

While the present has been described in connection with what is considered the most practical and preferred embodiments, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A method of producing wood substrate displaying simulated antique characteristics at the principal face of the wood substrate, comprising the steps of:
providing a structural substrate configured substantially as a parallelepiped having a principal face which will be exposed to view after the structural substrate is incorporated into an architectural construction;
imposing at least one distress feature directly onto the principal face of the structural substrate; and
limiting the number of structural substrates in the final product to one and only one structural substrate, which said one and only one structural substrate is that structural substrate which has had imposed thereon at least one distress feature.

2. The method of claim 1, wherein said step of imposing at least one distress feature comprises producing at least one simulated penetration into the principal face of the structural substrate, wherein each simulated penetration is a member of the group including nail holes, drilled holes, cracks, and pest infestation borings.

3. The method of claim 1, wherein said step of imposing at least one distress feature comprises the further step of simulating the appearance of putty filling of at least one recess formed in the simulated wood substrate.

4. The method of claim 1, comprising the further step of imposing at least one simulated surface abrasion marking into the structural substrate.

5. The method of claim 1, comprising the further step of sand polishing the principal face of the structural substrate prior to reproducing distress features.

6. The method of claim 2, comprising the further step of forming the structural substrate to a thickness within the range of six to twenty millimeters.

7. The method of claim 1, comprising the further step of forming an interconnection profile at the lateral surfaces of the structural substrate.

8. The method of claim 1, comprising the further step of staining at least the principal face.

9. The method of claim 1, comprising the further step of printing indicia on the principal face of the structural substrate, wherein the indicia simulates internal surface characteristics of natural wood.

10. The method of claim 9, wherein printing is accomplished using the further step of using printing rolls engraved with a natural wood grain pattern.

11. The method of claim 9, comprising an initial step of removing dust from the structural substrate prior to printing indicia on the principal face of the structural substrate.

12. The method of claim 9, comprising the further steps of
applying a water based seal to the structural substrate; and
drying the structural substrate using infrared radiation.

13. The method of claim 12, comprising the further steps of
applying water based staining at least to the principal face of the structural substrate; and
drying the structural substrate using a blower.

14. The method of claim 9, comprising the further step of drying at least the principal face of the structural substrate as a step which immediately follows printing indicia on the principal face of the structural substrate.

15. The method of claim 1, comprising the further steps of
applying an elastic sealer at least to the principal face of the substrate; and
drying the elastic sealer using ultraviolet radiation.

16. The method of claim 1, comprising the further steps of applying a sandable sealer at least to the principal face of the structural substrate; and
sanding the sealed principal face of the structural substrate.

17. The method of claim 1, comprising the further step of applying a topcoat to the structural substrate.

18. The method of claim 1, comprising the further step of applying a lacquer finishing coating at least to the principal face of the wood substrate.

19. A piece of wood substrate displaying simulated antique characteristics, fabricated by the method of claim 1.
